(19) United States
(12) Patent Application Publication
(10) Pub. No.: US 2026/0118105 A1
(43) Pub. Date: Apr. 30, 2026

(54) Concrete Masonry Block Measuring Apparatus

(71) Applicant: Dennis Hermansen, La Pine, OR (US)

(72) Inventor: Dennis Hermansen, La Pine, OR (US)

(21) Appl. No.: 19/369,075

(22) Filed: Oct. 24, 2025

Related U.S. Application Data
(60) Provisional application No. 63/711,491, filed on Oct. 24, 2024.

(51) Int. Cl. G01B 3/04; B25H 7/04

(52) U.S. Cl. CPC G01B 3/04; B25H 7/045

(57) ABSTRACT

A cutting block measuring tool for making measurements on a concrete block when positioned thereon. The measurement tool has a body with a diagonal edge with measurement indicia thereon. When a numeral of the indicia indicating a distance is aligned with a first edge of the block, that distance correlates to a distance from the second end of the block to a first side edge of the body, so a cut line may be placed on the block. An opening in the body is sized for marking a gang box cut out on the block.

This application claims priority to U.S. Provisional Patent Application Ser. No. 63/711,491 filed on Oct. 24, 2024. The present device relates to building structures from concrete blocks, also know as cinder blocks. More particularly, the disclosed device relates to a measuring tool adapted in configuration for marking such blocks for multiple cutting measurements used during construction.

### FIELD OF THE INVENTION

### Background of the Invention

Concrete blocks, also widely referred to as cinder blocks are a standard-size rectangular block used in building construction. The use of such concrete blocks formed with industry standard dimensions allows for structures to be designed remotely and then to be built in the traditional masonry style with layers of staggered blocks. Such concrete blocks are conventionally produced with hollow centers (cores). This hollow configuration reduces weight and improves insulation. The hollow cores also provide an interconnected void running between layers of a wall or the like into which concrete can be poured to solidify the entire wall after it is built. Such hollow cores also provide a path through the layers of blocks for the insertion of metal reenforcing bars. As such, concrete blocks are some of the most versatile building products available because of the wide variety of appearances that can be achieved using them in building construction.

Conventionally, concrete blocks are available in modular sizes, with the most popular typically referred to (by their thickness) as “4-inch”, “6-inch”, “8-inch”, and “12-inch”. In the United States, concrete blocks are nominally 16 inches long and 8 inches wide. However, their actual finished dimensions are ⅜ of an inch less than the nominal dimensions. These lessor dimensions allows for positioning of ⅜-inch mortar joints between blocks horizontally and vertically.

Block cores are typically tapered so that their upper surface has a greater surface on which to spread a mortar bed, and for easier handling. In the United States, the most widely used blocks have two cores, but three and four-core units are also produced. In addition to positioning of concrete within aligned cores in a wall structure the cores also allow for the insertion of steel reinforcement rods to span block layers in order to increase tensile strength. This is accomplished by grouting the voids of blocks containing reinforcing bar with concrete. Because of this reinforcement, concrete block walls are better able to resist lateral forces such as wind load and seismic forces.

During construction, masons must frequently make and mark measurements upon such blocks to change the block configuration to accommodate varied length layers of the wall and heights. They also must make measurements for various types of cut-outs to accommodate electrical and plumbing, as well as structural supports that engage with the wall being built.

The foregoing background concerning conventional cement blocks and structures and the limitations related therewith are intended to be illustrative and not exclusive, and they do not imply any limitations on the invention described and claimed herein. Various other limitations of the related art of cement blocks and the requirements for forming structures therewith are known or will become apparent to those skilled in the art upon a reading and understanding of the specification below and the accompanying drawings.

### SUMMARY OF THE INVENTION

The device herein provides a measuring square which is configured to provide masons a new, high quality, masonry multi tool. It is particularly well configured to aid masons and laborers in marking for cuts on a 7⅝″×15⅝″ concrete block. The device is configured to function for multiple tasks, including a jointer/sled runner, a tape measure configured for concrete block, an electric outlet opening template, and as a ⅜″ shim for marking cuts in the block.

The device provides a significant improvement in the ability of masons to measure and cut concrete blocks using a single device. The device features a planar body which extends from a base having a lower edge which is curved. On an upper side of the base, a ledge of the base projects perpendicular to both sides of the planar body coupled to the base to form a contact edge of the measuring square device herein with one edge of a concrete block. The planar body coupled to the base has a first side edge that runs perpendicular to the ledge of the base and a diagonal side edge that runs at an angle from a distal end of the first side edge to the base. This diagonal edge runs at a forty-five degree angle relative to the surface of the ledge of the base.

The measuring square device herein is configured to provide the user with an easy means to measure and concurrently mark cut lines a distance from an edge of a concrete block. Conventionally, such action is accomplished with a measuring tape and takes an inordinate amount of time to mark such cut lines. The block measuring tool herein provide an easy to position and easy to measure and mark a block for cut lines.

Positional indicia located adjacent the base and a perpendicular first side edge of the planar body, has a first line thereof which, if the device is properly positioned, may be easily read by the user. A second line of indicia located adjacent this first line, is imprinted upside down, relative to the view of the user, if the device is not properly placed to measure and mark a cut line. This positioning of position indicia makes it easy for a user to determine where to locate the device on a concrete block to make a measurement from an edge of the block to mark a cut line to reconfigure the block to a different size as required to fit on the wall being built.

In operation, the user locates the ledge of the device against one side edge of the concrete block. To draw the desired cut line on the concrete block which will allow it to be cut to the size desired by the user, with one edge positioned on the block edge, the device is slid to locate the numeral of the measurement indicia on the diagonal edge, in line with a one edge of the block which is perpendicular to the ledge. Using the device with the first side up and with the measurement indicia running from seven to fifteen, the numeral so aligned with the edge of the block correlates to a measurement distance from an opposite or second end of the block, to the first side edge of the planar body. The user may then employ a marker on the block adjacent the first side edge and have a cut line which is the distance from the second edge that equates to the numeral from the measurement indicia aligned with the first edge.

Using the device with the second side up allows for marking of cut lines which are a shorter distance from an end of the block The second side of the planar body has measurement indicia allowing marking of cut lines between one quarter inch to seven and three quarters inches. In this configuration of use, positioning the measurement indicia of the diagonal side edge of the body of the device aligned with a first edge of the block, will locate the first side edge of the planar body a correlating distance from that first edge of the block for marking. For example, positioning the numeral “5” of the measurement indicia aligned with the first edge of the block will locate the first side edge of the planar body five inches from the first side of the block.

The planar body, additionally, has an opening therein sized for that of a junction box for an electric socket or the like. To mark a desired cut out which has side edges perpendicular to the lower edge of a block and parallel to the side edge of a block easily, the user will again position the lower edge of a block on the ledge. They may slide the opening to a position desired for a cut out to be formed in the block for an electrical junction box or the like. Once so positioned, they may mark the block for an opening to be cut out by the user to accommodate electrical boxes. Of course, the opening may also be employed for larger gang boxes if desired.

With respect to the above description, before explaining at least one preferred embodiment of the herein disclosed cement block measuring and marking device and system in detail, it is to be understood that the invention is not limited in its application to the details of construction and to the arrangement of the components in the following description or as illustrated in the drawings. The cement block measuring tool device and system herein described and disclosed is capable of other embodiments and of being practiced and carried out in various equivalent ways which will become obvious to those skilled in the art upon reading this disclosure. Also, it is to be understood that the phraseology and terminology employed herein are for the purpose of description and should not be regarded as limiting.

As such, those skilled in the art, subsequent to reading this disclosure, will appreciate that the conception upon which this disclosure is based may readily be utilized as a basis for the designing of other cement block measuring and marking tools and substantially equivalent structures methods and systems for carrying out the several purposes of the present disclosed measuring device. It is important, therefore, that the claims be regarded as including such equivalent configurations, constructions, and methodology insofar as they do not depart from the spirit and scope of the present invention.

As used in the claims to describe the various inventive aspects and embodiments, “comprising” means including, but not limited to, whatever follows the word “comprising.” Thus, use of the term “comprising” indicates that the listed elements are required or mandatory, but that other elements are optional and may or may not be present. By “consisting of” is meant including, and limited to, whatever follows the phrase “consisting of.” Thus, the phrase “consisting of” indicates that the listed elements are required or mandatory, and that no other elements may be present. By “consisting essentially of” is meant including any elements listed after the phrase, and limited to other elements that do not interfere with or contribute to the activity or action specified in the disclosure for the listed elements. Thus, the phrase “consisting essentially of” indicates that the listed elements are required or mandatory, but that other elements are optional and may or may not be present depending upon whether or not they affect the activity or action of the listed elements. The term “substantially,” unless otherwise specifically defined, means plus or minus five percent.

It is an object of the present invention to provide a measuring and marking tool for cement blocks which allows the user to take and mark measurements upon cement blocks to alter the blocks as needed for as-built requirements.

It is another object of this invention to provide such a measuring and marking tool which correlates measuring indicia on a diagonal side which may overhang one side of a block, to a distance from the opposite side from the overhang, to a first side edge of the device to allow for easy measuring and marking or a wide variance in such distances easily.

These and other objects, features, and advantages of the present cement block measuring and marking tool device and system herein as well as the advantages thereof over existing prior art, which will become apparent from the description to follow, are accomplished by the improvements described in this specification and hereinafter described in the following detailed description which fully discloses the cement block measuring and marking device and system herein, but should not be considered as placing limitations thereon.

### BRIEF DESCRIPTION OF DRAWING FIGURES

The accompanying drawings, which are incorporated herein and form a part of the specification, illustrate some, but not the only or exclusive examples of embodiments and/or features of the disclosed cement block measuring and marking tool device and system and configurations herein. It is intended that the embodiments and figures disclosed herein are to be considered illustrative of the invention herein, rather than limiting in any fashion.

In the drawings:

FIG. 1 shows a first or front surface of the cement block measuring and marking tool showing measurement indicia thereon.

FIG. 2 shows a second or rear surface of the cement block measuring and marking tool of FIG. 1 showing measurement indicia thereon.

FIG. 3 is an end view of the measuring and marking tool of FIGS. 1-2 showing ledges on opposing sides of the center portion and a curved lower surface.

FIG. 4 shows an overhead perspective view of the measuring and marking tool of FIG. 1 in a first positioning for measuring depicting a lateral measuring function enabled by the measurement indicia on an angled section of the marking tool.

FIG. 5 shows the resultant marking of the concrete block of FIG. 4 where the measurement indicia on the angled portion is marked by a line from the edge of the block.

FIG. 6 shows the measuring and marking tool herein positioned on an opposite end and side of a block whereby the measurement indica on the angled portion enables the marking of a line positioned the distance of the indicia from the opposing side of the block.

FIG. 7 depicts a view of the block from FIG. 6 and shows the line which was marked using the measurement from the diagonal portion indicia.

FIG. 7A shows a second positioning of the device herein for measuring for cut lines wherein shorter measurements from the side of the block on which the diagonal side edge is placed may be made for marking cut lines.

FIG. 7B depicts the cut line which may be imparted to the block using the second positioning of the device as shown in FIG. 7A.

FIG. 8 shows the measuring and marking tool herein positioned with a block for imparting a measurement of a box on the block.

FIG. 9 shows the block of FIG. 8 wherein a box is marked for an electrical junction box using the opening of the tool of FIG. 8.

FIGS. 10A-10D depict the use of the capabilities of the measuring and marking tool herein through different positioning of the tool upon a block.

### DETAILED DESCRIPTION OF THE INVENTION

In this description, the directional prepositions of up, upwardly, down, downwardly, front, back, top, upper, bottom, lower, left, right, first, second, and other such terms refer to the configuration of the cement block measuring and marking tool device and system and the like herein as it is oriented and appears in the drawings, and all such terms are used for convenience only and such are not intended to be limiting or to imply that the disclosed device has to be used or positioned in any particular orientation.

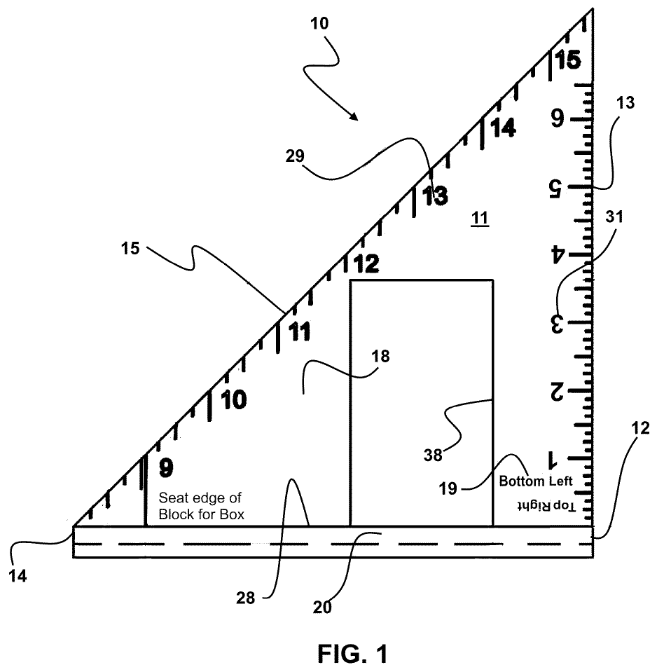

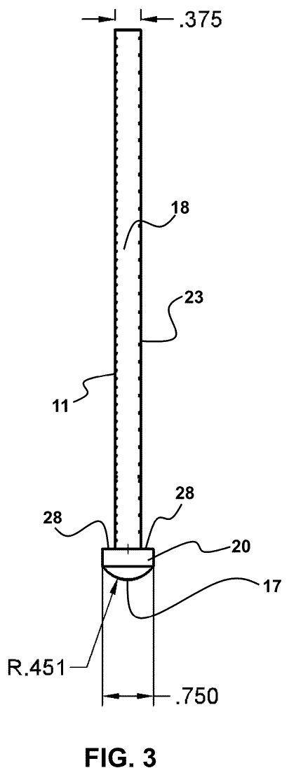

Now referring to drawings in FIGS. 1-10, there is depicted in FIG. 1 an overhead view of the block measuring device 10 showing a base 12 extending from a first end 14 of the base to a second end 16 of the base 12. The base 12 has a planar body 18 extending above which including the base 12 forms a triangular shape. As shown in FIG. 3, the base 12 has a ledge 28, from which the planar body 18 extends, and the ledge 28 extends perpendicular to the first side 11 and second side 23 of the planar body 18. The lower surface 17 of the base 12 is curved. While modes of the device 10 herein may be provided without a base 12 and the lower edge aligned with the block 20 by hand and eye, the provision of the base 12 with a ledge 28 to contact the planar edge of a block 20 ensures that all markings are perpendicular to two sides and parallel to the others.

As shown in FIG. 1, the planar body 18 of the device 10 has a first side edge 13 extending substantially perpendicular from and aligned with the first end 14 of the base 12. The planar body 18 has a diagonal side edge 15 extending between the second end 16 of the base 12 and a distal end of the first side edge 13. The same configuration is shown in FIG. 3 with the planar body 18 having a second side surface 23.

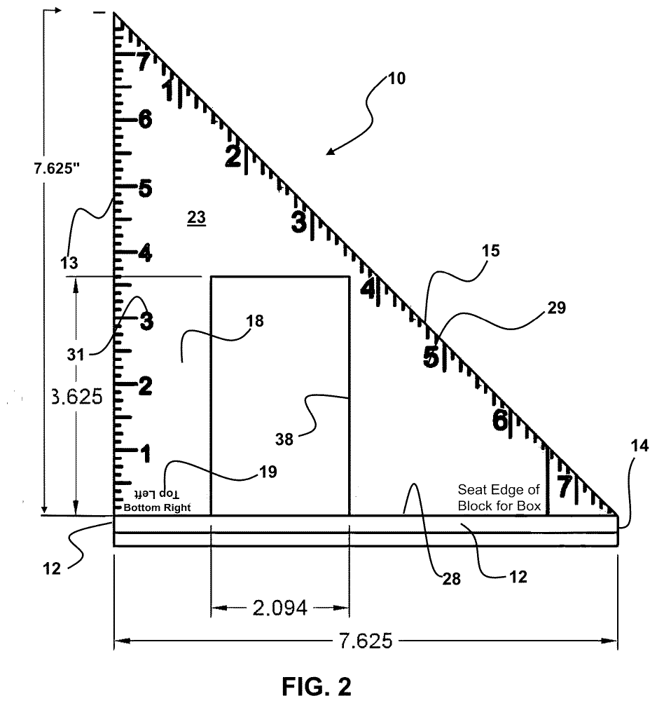

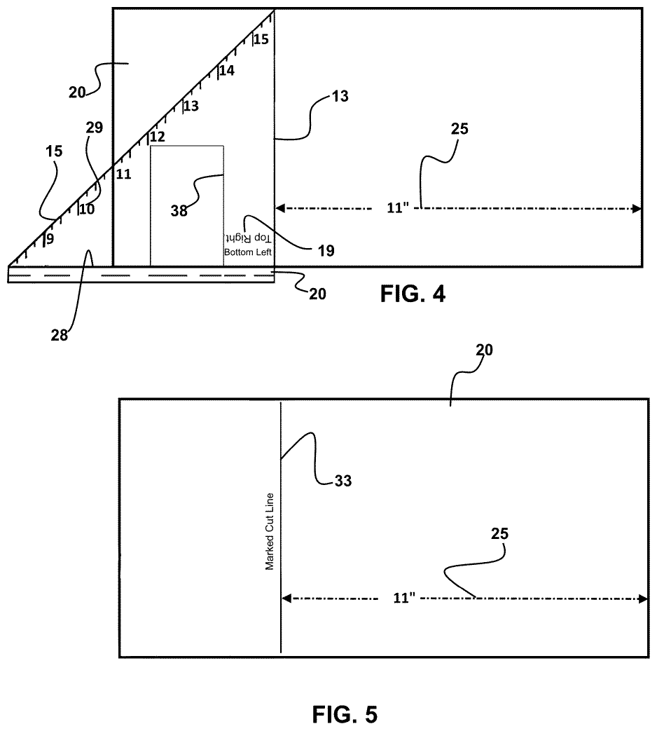

On this first side surface 11, shown in FIG. 1, and the second side surface 23, shown in FIG. 2, of the planar body 18 is located measurement indicia 29. Adjacent to the base 12 and the first side edge 13 is shown positioning indicia 19. As can be seen in FIG. 1, the positioning indicia 19 on the first side surface 11 has one line of text indicating “Bottom Right” which is legible with the long edge of the block 20 located on the ledge 28 of the base 12, and with the diagonal side edge 15 overhanging a left side of a block 20, such as in FIG. 4. The positioning indicia 19 being right side up is thus a position indicated to the user that they have the device 10 positioned correctly to mark a measurement from the opposite side from that which the diagonal side edge 15 overhangs.

Such, for example, is shown in FIG. 4 where the diagonal side edge 15 overhangs one end of the block and the device 10 is positioned adjacent the bottom left corner thereof. In this proper positioning the positioning indicia so positioned places “bottom left” of the positioning indicia 19 right side up when the device 10 is properly positioned to mark a cut line measurement from the side of the block opposite the one the diagonal side edge 13 overhangs. The positioning indicia indicating “top right” is upside down and hard to read. By right side up herein is meant the letter of words are legible from left to right in a conventional fashion. By upside down herein is meant the letter of the indicia are inverted or illegible easily as they must be read upside down and from right to left.

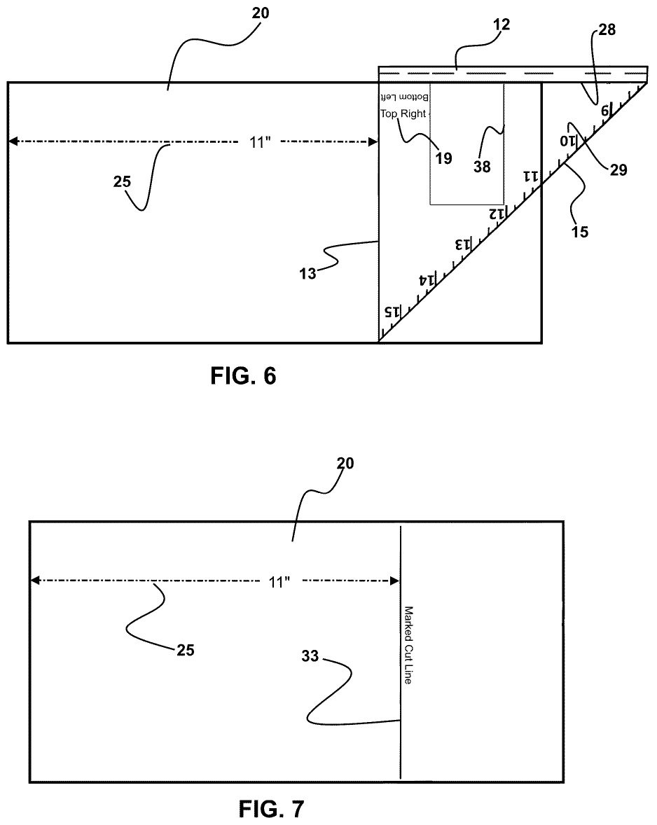

The upside down indicia in the positioning indicia 19 which indicates “top right” will be legible right side up to a user when the device 10 is positioned as in FIG. 6, where the diagonal side edge 15 overhangs one side of the block 20 and as viewed from overhead, the device 10 is located adjacent the top right side of the block 20. Thus a portion of the positioning indicia 19 is right side up and legible with the device 10 positioned properly for a cut line measurement as in FIGS. 4, 6, and 8, to let the user know the device is properly located and in contact with the block 20 to make the measurement with the measurement indica 29 running along the diagonal side edge 15 which correlates to the distance from the side edge of the block opposite that the diagonal edge 15 overhangs and to the first side edge 13. It should be noted that the positioning indicia 19 may be abbreviations of the words such as “BL” for bottom left and “TR” for top right and they would still be in the same upside down or right side up position depending on the positioning of the device 10.

This measuring and marking is clearly shown in FIG. 4 where the line of the measurement indicia 29 correlating to numeral “11” on the measurement indicia 29 is aligned with the left side edge with the block 20 viewed from overhead. The distance from the right side edge to the first side edge 13 as shown, is “11” inches and can be marked with a marker to leave a cut line as shown in FIG. 5. The user, as such, needing to cut eleven inches from the right side of a block 20 as viewed overhead, can place the line correlating to the numeral “11” on the diagonal side edge 15 in alignment with the first or left hand edge of the block 20. The user may then run a marker upon the block 20 where the first side edge 13 is located and have the proper distance for a cut line, as in FIG. 5 marked.

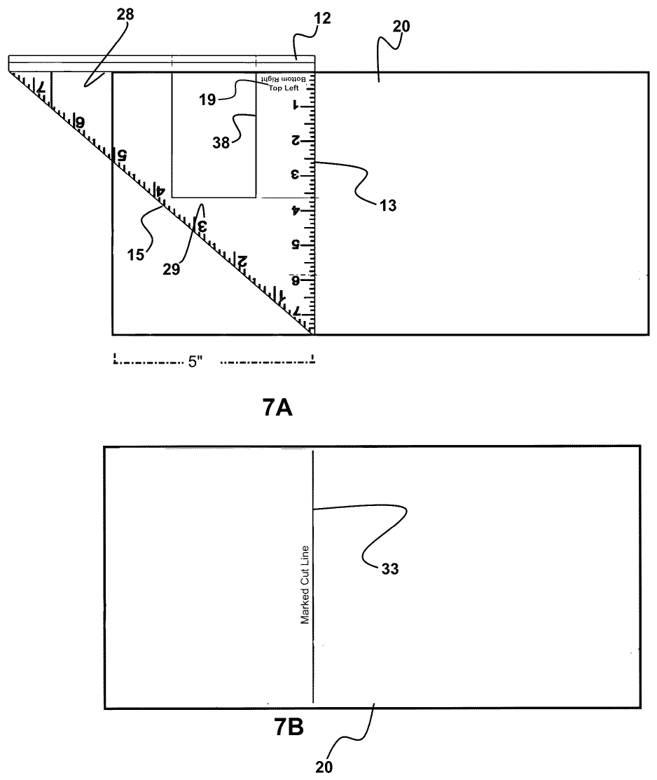

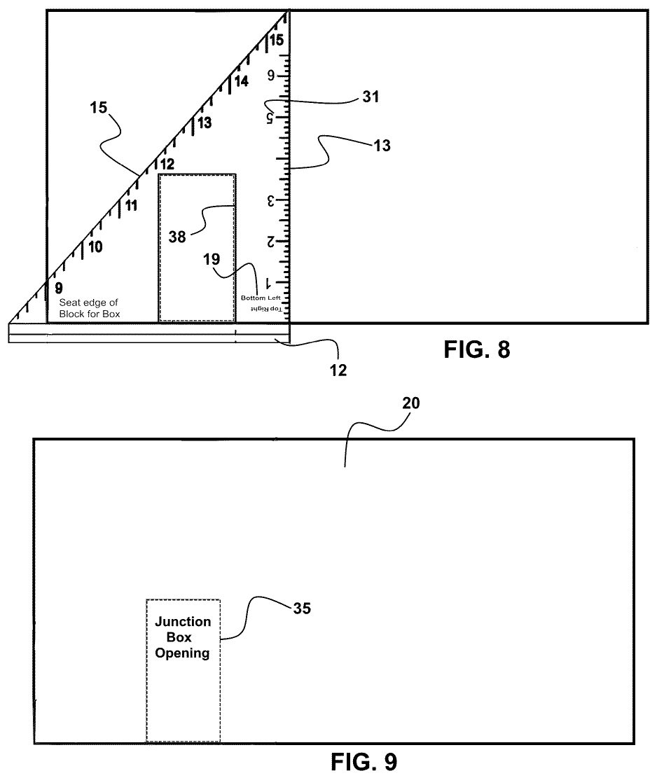

Should the user want twelve inches they would align the line correlating to “12” on the measurement indicia 29 with the device in the “bottom left” position of FIG. 4 or FIG. 8 and mark a line on the block along the first side edge 13. This cut line measurement works for any of the numerals of the measurement indicia 29 with the device 10 properly positioned as indicated by the positioning indicia 19, such as shown in FIGS. 4, 6, and 8. The first side edge 13 will always be located a measured distance from the edge of the block opposite the edge which the diagonal side edge 15 overhangs, and that measured distance 25 which is equal to the numeral of the measurement indicia 29 which is aligned with the edge of the block it overhangs.

It should be further noted that in all positioning of the device 10 to mark cut lines 33 or box cutouts 35, one side edge of the block 20 must be positioned on a ledge 28 to properly locate the measurement indicia 29 positioned on the planar body 18 relative to the block 20 to be measured. Also, as noted, the user must ascertain for making cut lines 33 from cut line measurements 25 that the position indicia 19 is right side up to show the proper location of the device 10 upon the surface of a block 20.

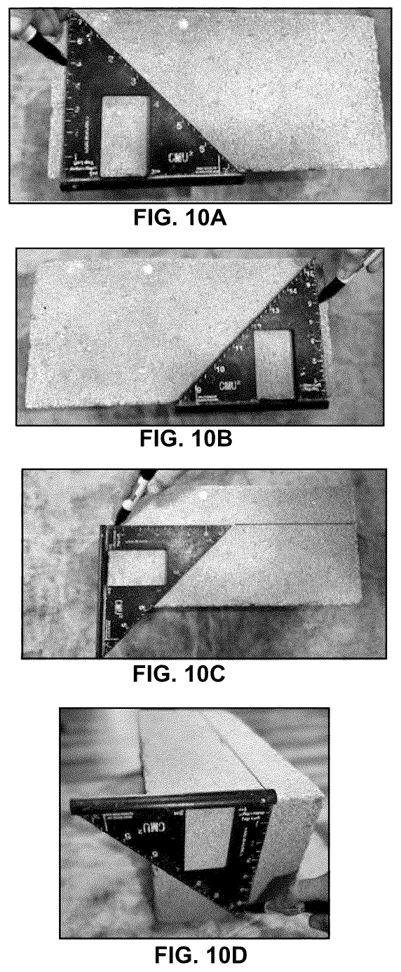

As noted FIGS. 10A-10D, show the employment of the device 10 to form cut lines on a block horizontally there across along the long direction, which are straight and parallel to both the top and bottom edges as well as perpendicular to the two shorter side edges of the block 20. Using the secondary measurement indicia 31 running along the first side edge 13 with one side surface of the block 20 positioned on the ledge 28, a distance measurement may be placed on the block 20. By flipping the device 20, as in FIG. 10B, the same distance measurement may be positioned at an opposite end of the block 20. As shown in 10C, using the two marked distances the first side edge 13 is employable as a guide to draw a straight line across the block 20. This marking may be done in the same fashion on the opposite side of the block 20. The same distance marking as shown in FIG. 10D may be placed on the short side edges of a block 20 to thereby define a cut line which is straight and parallel to both long side edges of the block for the user to trim the block 20. The provision of contact of the side edges of the block 20 with the ledge 28 during all such measurements ensures that the cut lines, when marked, run parallel to two side edges and perpendicular to the two ends, thereby insuring that the block 20 may be installed in a manner where sides appear parallel and perpendicular to the sides of adjacent blocks 20.

Additionally, while the description of the positioning of the planar body 18 of the device 10 is described with the first side 11 being viewable and the second side surface 23 being in contact with the block 20 surface. As shown in FIG. 7A, this positioning can be reversed from a first positioning of the device 10 for a measurement with the first surface 11 up, to a second positioning of the device 10 with the second surface 23 upward, where shorter measurement distances 25 for cut lines 33 from a side of the block 20 are desired.

As shown in FIG. 7A, a second positioning the planar body 18 with the diagonal side edge 15 overhanging one side of a block 20 with the second side surface 23 being viewable, allows for shorter measurement distances 25 for marking cut lines 33, such as shown between 1-7 inches. Using the device 10 in this manner, placing a numeral of the measurement indicia 29 along the diagonal side edge 15 aligned with a first side edge of the block 20, positions the first side edge 13 a correlating distance from that first side edge whereby a cut line 33 may be marked for the shorter distance.

As shown herein, the device 10 is also positionable in a coupling upon a block 20 with one edge of the block 20 located upon the ledge 28 to measure and mark cut outs for junction boxes used for electrical outlets and the like. As shown in FIG. 8, with long side or short side edge of the block 20 positioned upon the ledge 28, an opening 38 is located wherein a side surface of the block is viewable therethrough. The opening 38 as shown is sized for that of a one-gang junction box which is substantially 2.25 inches on the shorter side by 3.63 inches on the long side. The device 10, as shown, with the block positioned upon the ledge 28 may be employed to mark an area for a cut out in the block 20 for positioning of an electrical junction box. Of course, the size of the opening 38 may be configured for larger gang boxes or other components. This positioning of the block 20 on the ledge 28 insures that the cut out for a box has sides which are parallel to both side edges of a block 20 and top and bottom edges that are parallel to the top and bottom edges of a block 20 and insures any electric socket or switch mounted in a gang box in the block appears plum and professionally installed.

As shown in FIG. 9, cut out line 35 may be marked with a marker on the side surface of a block 20 when the device 10 is positioned as in FIG. 8, or a similar positioning, to allow the user to then employ a tool to make the cut out for a junction box opening in the block 20.

As noted, any of the different configurations and components of the cement block measuring and marking tool device and method of employment thereof, have been shown and described herein can be employed with any other configuration or component shown and described as part of the system herein. Additionally, while the disclosed invention has been described herein with reference to particular embodiments thereof and components thereof operatively engaged for operation, a latitude of equivalent modifications, various changes, and substitutions are intended in the foregoing disclosures and it will be appreciated that in some instance some features, or configurations, or operations of the invention could be employed without a corresponding use of other features without departing from the scope of the invention as set forth in the following claims. All such changes, alterations, and modifications, as would occur to those skilled in the art subsequent to reviewing this specification, are considered to be within the scope of this invention as broadly defined in the appended claims.

Further, the purpose of any abstract of this specification is to enable the U.S. Patent and Trademark Office, the public generally, and especially the scientists, engineers, and practitioners in the art who are not familiar with patent or legal terms or phraseology, to determine quickly from a cursory inspection the nature and essence of the technical disclosure of the application. Any such abstract included herein is neither intended to define the invention of the application, which is measured by the claims, nor is it intended to be limiting, as to the scope of the invention in any way.

What is claimed is:

1. A measuring apparatus for concrete blocks comprising:
a planar body having a first side surface and a second side surface;
said planar body having a first side edge extending to a distal end thereof, from a base;
said planar body having a diagonal side edge extending between said base and said distal end of said first side edge;
measurement indicia running along said diagonal side edge on said first side surface;
said planar body for positioning upon a block in a first positioning with said second side surface contacting said block and diagonal edge extending over a first end of said block;
a numeral of said measurement indicia when aligned with said first end of said block with said planar body in said first positioning indicating a length distance, said length distance correlating to a measurement distance from a second side of said block to said first side edge; and
whereby a line may be drawn upon said block along said side edge of said planar body at said measurement distance.

2. The concrete block measuring apparatus of claim 1 additionally comprising:
said base having a ledge extending away from both said first side surface and said second side surface; and
said ledge for providing a contact with an edge of said block extending between said first end and said second end thereof; and
said contact maintaining said first side edge perpendicular to said ledge.

3. The concrete block measuring apparatus of claim 1 additionally comprising:
said planar body positionable to said first positioning adjacent any of four corners of said block; and
positioning indicia located on said first side surface having one line of which is right side up and legible with said planar body correctly located to said first positioning adjacent one of said four corners and having a second line of which is upside down.

4. The concrete block measuring apparatus of claim 2 additionally comprising:
said planar body positionable to said first positioning adjacent any of four corners of said block; and
positioning indicia on said planar body, said positioning indicia having one line of which is right side up and legible with said planar body correctly located to said first positioning adjacent one of said four corners and having a second line of which is upside down.

5. The concrete block measuring apparatus of claim 1 additionally comprising:
secondary measurement indicia running along said diagonal side edge on said second side surface;
said planar body for positioning upon a block in a second positioning with said first side surface contacting said block and said diagonal edge extending over a first side of said block;
a numeral of said secondary measurement indicia when aligned with said first end said block with said planar body in said second positioning indicating a secondary length distance, said secondary length distance correlating to a measurement distance from said first side of said block to said first side edge; and
whereby said line may be drawn upon said block along said first side edge of said planar body at said secondary measurement distance.

6. The concrete block measuring apparatus of claim 2 additionally comprising:
secondary measurement indicia running along said diagonal side edge on said second side surface;
said planar body for positioning upon a block in a second positioning with said first side surface contacting said block and said diagonal edge extending over a first side of said block;
a numeral of said secondary measurement indicia when aligned with said first end of said block with said planar body in said second positioning indicating a secondary length distance, said secondary length distance correlating to a measurement distance from said first side of said block to said first side edge; and
whereby said line may be drawn upon said block along said first side edge of said planar body at said secondary measurement distance.

7. The concrete block measuring apparatus of claim 5 additionally comprising:
said planar body positionable to said second positioning adjacent any of four corners of said block; and
positioning indicia located on said second side planar body one line of which is right side up and legible with said planar body correctly located to said second positioning adjacent one of said four corners, and having a second line of which is upside down.

8. The concrete block measuring apparatus of claim 6 additionally comprising:
said planar body positionable to said second positioning adjacent any of four corners of said block; and
positioning indicia located on said second side of said planar body one line of which is right side up and legible with said planar body correctly located to said second positioning adjacent one of said four corners, and having a second line of which is upside down.

9. The concrete block measuring apparatus of claim 2 additionally comprising:
an opening communicating through said planar body;
said opening for marking a gang box marking on said block.

10. The concrete block measuring apparatus of claim 3 additionally comprising:
an opening communicating through said planar body;
said opening for marking a gang box marking on said block.

11. The concrete block measuring apparatus of claim 4 additionally comprising:
an opening communicating through said planar body;
said opening for marking a gang box marking on said block.

12. The concrete block measuring apparatus of claim 5 additionally comprising:
an opening communicating through said planar body;
said opening for marking a gang box marking on said block.

13. The concrete block measuring apparatus of claim 6 additionally comprising:
an opening communicating through said planar body;
said opening for marking a gang box marking on said block.

14. The concrete block measuring apparatus of claim 7 additionally comprising:
an opening communicating through said planar body;
said opening for marking a gang box marking on said block.

15. The concrete block measuring apparatus of claim 8 additionally comprising:
an opening communicating through said planar body;
said opening for marking a gang box marking on said block.

16. The concrete block measuring apparatus of claim 2 wherein said block is 7⅝″×7⅝″×15⅝.″

17. The concrete block measuring apparatus of claim 4 wherein said block is 7⅝″×7⅝″×15⅝.″

18. The concrete block measuring apparatus of claim 5 wherein said block is 7⅝″×7⅝″×15⅝.″

19. The concrete block measuring apparatus of claim 12 wherein said block is 7⅝″×7⅝″×15⅝.″

20. The concrete block measuring apparatus of claim 15 wherein said block is 7⅝″×7⅝″×15⅝.″
